(19) United States
(12) Patent Application Publication
(10) Pub. No.: US 2002/0194135 A1
(43) Pub. Date: Dec. 19, 2002

(54) System and method for providing e-services

(76) Inventors: Stuart Taylor, Cupertino, CA (US); Jean-Marc Villaret, Paris (FR); Kevin Ritschel, San Jose, CA (US)

Correspondence Address: HEWLETT-PACKARD COMPANY, Intellectual Property Administration, P.O. Box 272400, Fort Collins, CO, 80527-2400, US

(21) Appl. No.: 09/882,625

(22) Filed: Jun. 15, 2001

(51) Int. Cl. G06F 17/60

(52) U.S. Cl. 705/64

(57) ABSTRACT

The present system and method involves a multi-application terminal that comprises a memory for storing a plurality of payment and non-payment applications, a memory management unit for separating said applications in said memory. This permits said non-payment applications to exist side-by-side with said payment application without requiring additional certification. The multi-application terminal also comprises a processor for executing one or more applications, said memory management unit operable to assign a protected region within said memory to each application being executed by said processor. Said payment applications are operable to provide payment related services over a secured financial network and said non-payment applications operable are to provide non-payment related services over an open network.

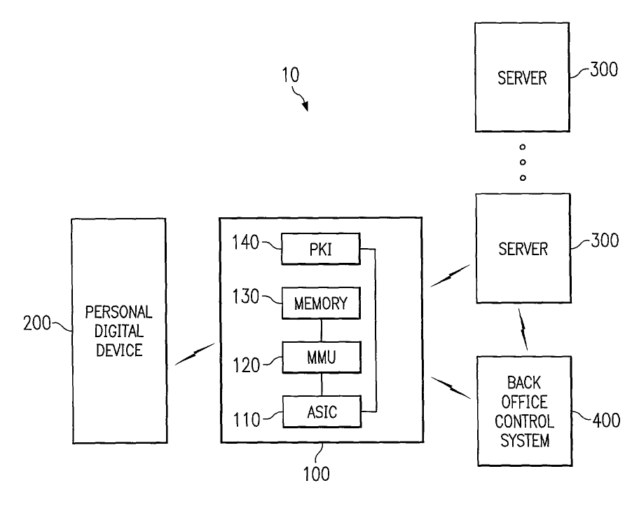

### RELATED APPLICATIONS

The present invention is related to commonly assigned, co-pending, and concurrently filed U.S. patent application Ser. No. [Attorney Docket No. 10013330-1], entitled “HOT SYNC THROUGH POS TERMINAL,” and U.S. patent application Ser. No. [Attorney Docket No. 10013263-1], entitled “EMV CARD-BASED IDENTIFICATION, AUTHENTICATION, AND ACCESS CONTROL FOR REMOTE ACCESS,” the disclosures of which are hereby incorporated herein by reference.

### TECHNICAL FIELD

The present invention relates to a system and method for supporting a plurality of applications on a payment terminal, more particularly, to providing payment and non-payment related services, such as e-services.

### BACKGROUND

Only a decade ago, a merchant could accept a single type of credit card and satisfy most customers. That has changed dramatically with the proliferation of card-based payment, payment-related and even non-payment options in the highly competitive retail marketplace. This has added significantly to the complexity of today's e-payment environment. Today, many customers carry a variety of cards, and they expect retailers to readily accept whichever card they choose for a given purchase. To compete effectively in this environment, merchants have offered a growing variety of credit and debit services, using various devices, such as a credit card swiper, a credit card authorization device, an electronic fund transfer point of sale device (EFTPOS) or a payment terminal or device, to enhance convenience and encourage customers to patronize their stores. Additionally, the payment device can be linked to the cash register.

Merchants are always looking for new ways to enhance convenience and increase sales, while reducing costs. As payment terminals have become more powerful and sophisticated, they offer the potential to move into the mainstream of retail operations, such as providing an way to capitalize on untapped opportunities by supporting an array of value-added, non-payment applications. This changing environment has created a need for a single terminal capable of supporting multiple payment, payment-related and non-payment applications efficiently, securely and cost-effectively.

Typically, the payment device accepts, processes and authorizes payment by various means, such as a credit card, debit card, smart card, check, etc. However, the payment device and its related services are not free, the merchant or retailer generally pays for the payment device itself and a percentage of each sale for processing each payment through the payment device. In other words, the payment device is a cost center to the retailer. Accordingly, it is desirable to offer other types of services on the payment device that the merchant can sell or offer to its customers, thereby minimizing the cost of operating the payment device.

In a typical retail model or environment, the merchant has all of its merchandise on display to the consumer for a possible sale. The consumer comes to the retail store and selects various merchandise from the shelves for purchase. At the check-out counter, the merchant or merchant's cashier only totals the customer's purchases and accepts payment in either cash, check, credit card, debit card or other electronic methods. That is, the merchant utilizes the payment device to obtain authorization for customer's check, credit or debit card via a secured financial network. Therefore, it is desirable for merchants to convert the payment devices from cost centers to profit makers. For example, the payment devices of the present invention can be used to offer various e-services to customers, such as selling tickets for a concert, a sporting event, a movie, or any other event. That is, the merchant or customer accesses one of the e-services offered on the payment device of the present invention via an Internet connection and the merchant provides a printed ticket to the consumer after securing payment from the consumer via the normal financial connection. It is appreciated that the tickets can be printed directly from the payment device or from another device connected to the payment device.

In the past, several smaller applications were linked together to become a single, larger piece of code within a traditional e-payment environment. However, because payment applications involve money, these applications must undergo a stringent certification process before they can be used. As a result, each time a change is made to any piece of a large monolithic application or a new application is added, the entire piece of code must be re-certified, at a significant cost to the developer and merchant. That is, even relatively minor changes to one of the programs or routines within a larger payment application can result in substantially increased development expenses and a slower time to market. Additionally, the stringent certification process adds a significant barrier to entry into this market. Accordingly, off-the-shelf terminals or PCs cannot simply be used to provide e-payment and non-payment services to the merchants.

Also, there can also be significant performance penalties and unacceptably long download times with large, linked-together applications. This can tie up merchant's terminals, drive up telecommunications costs and greatly extend the time required to update all the terminals in a network. Finally, whenever a new function is added or changes are made to an existing large, monolithic application, there is an increased risk of corruption to the entire application code. This can create difficulties for banks, processors, developers, and merchants alike.

### SUMMARY OF THE INVENTION

The present system and method involves a multi-application terminal that comprises a memory for storing a plurality of payment and non-payment applications, a memory management unit for separating said applications in said memory. This permits said non-payment applications to exist side-by-side with said payment application without requiring additional certification. The multi-application terminal also comprises a processor for executing one or more applications, said memory management unit operable to assign a protected region within said memory to each application being executed by said processor. Said payment applications are operable to provide payment related services over a secured financial network and said non-payment applications operable are to provide non-payment related services over an open network.

### BRIEF DESCRIPTION OF THE DRAWING

The FIGURE is a block diagram showing the incorporation of the present invention within an e-payment environment.

### DETAILED DESCRIPTION

The present system and method utilizes multi-application software and/or hardware architecture to support both payment and non-payment related services, such as e-services.

That is, one application can relate to the currently available financial products or services on the current payment terminals via a secure financial connection, such as processing and authorizing payments via credit cards, debit cards, checks, etc. The other applications can relate to various e-services, i.e., electronic products and services, that can be provided over the Internet, i.e., TCP/IP connection. In accordance with an aspect of the present invention, the payment terminal or device can be POS terminal, kiosk or vending machine.

In accordance with an embodiment of the present invention, the system and method utilizes a hardware/software application separation mechanism that permits applications to safely exist side-by-side without corrupting one another. This advantageously makes it easier and faster to add, modify or download applications. Additionally, since individual applications can remain physically separate and not be linked into a single piece of code, no additional certifications are required for an existing application when adding or changing a payment-related or non-payment application. Further, this enables the developers or merchants to perform partial downloads of the new applications or required functions, rather than a large, monolithic piece of code, thereby saving substantial amounts of time and money, and minimizing inconvenience to a merchant's customers.

In accordance with another embodiment of the present invention, the system and method enables a consumer to access the POS terminal, kiosk, payment device, and/or peripheral device, i.e., a publicly accessible device, using a private hand-held or portable device, such as a cell phone, beeper, two-way radio, smart phone, communicator, personal digital assistant (PDA), etc. That is, the consumer can use his/her private mobile appliance to browse through various content resident or accessible through the POS terminal, kiosk or payment device.

In accordance with a further embodiment of the present invention, the system and method further enables the consumer to access various network servers and Internet web sites to purchase goods and/or services via the POS terminal, kiosk, payment device, etc. using his/her private mobile appliance. The e-service provider can also communicate with the merchant and/or the consumer via the POS terminal. For example, the e-service provider can send an electronic confirmation, receipt and the like.

The present invention is readily implemented by presently available communication apparatus and electronic components. The invention finds ready application in virtually all commercial communication networks, including but not limited to a telephone network, a wireless network, a local area network (LAN), a wide area network (WAN), intranet, world wide web (Internet), and a wired cable transmission system.

The FIGURE shows system 10 having multi-application terminal or e-services dispenser 100 supports a multi-application e-payment environment, thereby permitting merchants to securely run multiple payment, payment-related and non-payment applications created by different developers on the same platform. In accordance with an embodiment of the present invention, the multi-application terminal utilizes a hardware/software approach that enables various applications to safely exist side-by-side without corrupting one another.

Preferably, multi-application terminal 100 includes custom-designed application specific integrated circuit (ASIC) 110 to run the various payment and non-payment related applications, memory management unit (MMU) chip 120 that provides physical separation for all applications in memory 130, assigning protected regions within the multi-application terminal's memory for various applications running on the multi-application terminal at any given time. MMU 120 checks to determine whether any operations are inadvertently or intentionally trying to access memory outside of their allocated space. If it is determined that any application is attempting access memory outside its allocated space, MMU 120 can immediately stop the task or shut down the system before other applications are corrupted. This advantageously makes it easier and faster to add, modify or download applications. Additionally, since individual applications can remain physically separate and not be linked into a single piece of code, no additional certifications are required for an existing application when adding or changing a payment-related or non-payment application. Further, this enables the developers or merchants to perform partial downloads of the new applications or required functions, rather than a large, monolithic piece of code, thereby saving substantial amounts of time and money, and minimizing inconvenience to a merchant's customers. It is appreciated that the information between various applications can be shared using libraries and a common application program interface (API).

In accordance with another embodiment of the present invention, multi-application terminal 100 comprises public key infrastructure (PKI) based software application 140 for authenticating files to prevent the execution of unauthorized software on multi-application terminal 100. This advantageously minimizes the possibility of unauthorized files, such as non-supported software, running on multi-application terminal 100 and interfering or corrupting other applications. In accordance an aspect of the present invention, for software application to be authenticated on multi-application terminal 100, the file is digitally “signed” by an authorized party.

Accordingly, multi-application terminal 100 of the present invention is simply more than a credit card swiper, wherein either the merchant or customer swipes the card to authorize payment of the purchased product or services. The multi-application terminal not only supports financial applications via connection to back office control system 400 over a secure network (wireless or wire line) controlled by the financial institutions, but can be used to access e-services over an open network (wireless or wire line), such as the Internet via server(s) 300.

In accordance with an embodiment of the present invention, the multi-application terminal of the present invention has payment applications to process various electronic payments, i.e., credit card authorization, check authorization, etc., and other various applications to support various e-services, such as e-reservation services wherein the consumer can make reservations for a restaurant, e-takeout services wherein the consumer can order food for takeout and/or delivery, e-ticketing services wherein the consumer can purchase tickets for a concert, a sporting event, a movie, etc. Also, it can be used to purchase CDs, DVDs, wherein the desired movie, song, or album is downloaded onto a CD or DVD, electronic books, pre-paid telephone cards, and the like.

Continuing in the FIGURE, there is illustrated an example of how the e-services dispenser or multi-application terminal 100 operates in a retail environment. The consumer accesses multi-application terminal 100 using his/her mobile or portable appliance 200, such as a cell phone, personal digital assistant (PDA), beeper, or digital device via a wireless connection. The wireless connection can be established using any known techniques, including but not limited to wireless application protocol (WAP), shared wireless access protocol, wireless LAN or WLAN, IrDA, bluetooth, PAN, etc. Bluetooth is a short-range radio technology aimed at simplifying communications among net devices and between devices and the Internet. IrDa is short for Infrared Data Association, a group of device manufacturers that developed a standard for transmitting data via infrared light waves. Personal Area Network (PAN) is an IBM technology based on the electric-field transmission medium that allows individuals to exchange data with a simple touch or grasp. Multi-application terminal 100 is connected on one or more back end servers 300 to provide requested e-services, contents, etc. over the intranet or Internet. The multi-application terminal can be connected to back end server(s) 300 over a wired or wireless connection.

The consumer can access one or more servers 300 to purchase various goods and/or services from various e-service providers, such as a pizza store, restaurant, ticketing agency, etc. For example, the consumer can order pizza from a pizza store, i.e., e-service provider, using multi-application terminal 100. Using portable appliance 200, the consumer access server 300 associated with the appropriate pizza store via multi-application terminal 100 to order the pizza. Preferably, portable appliance 200 can also transmit consumer information to the e-service provider or server 300, such as telephone number, delivery address, delivery time, etc. Alternatively, the consumer can use the multi-application terminal 100 to access his/her portal containing his/her personal information, i.e., address, preferred payment method, telephone number, payment history, order history, preferred e-service provider, links to his/her favorite sites, etc. Upon receiving and/or processing the order, the e-service provider can transmit an electronic confirmation and/or receipt of the order to the merchant (i.e., multi-application terminal 100) and/or the consumer (i.e., portable appliance 200). It is appreciated that these various electronic information can be “beamed” to portable appliance 200 from multi-application terminal 100 over the wireless connection. Additionally, the merchant or the consumer can authorize payment for the order using multi-application terminal 100. It is appreciated that since the consumer, merchant and e-service provider are electronically connected, information (i.e., consumer data) stored or contained in various devices, such as portable appliance 200, multi-application terminal 100 and server 300, can be synchronized as described in commonly assigned, co-pending U.S. patent application Ser. No. [Attorney Docket No. 10013330-1], entitled “HOT SYNC THROUGH POS TERMINAL,” the disclosure of which is hereby incorporated herein be reference in it's entirety.

Alternatively, the merchant can use portable appliance 200 to manage and maintain multi-application terminals 100, such as downloading records, uploading new applications, etc.

The inventive system and method enables a consumer to access a publicly accessible kiosk or payment device with a private hand-held or portable device or appliance, such as a cell phone, beeper, two-way radio, smart phone, communicator, personal digital assistant (PDA), etc. The consumer uses his/her private mobile appliance to browse through various content resident or accessible through the kiosk or payment device.

What is claimed is:

1. A multi-application terminal, comprising:
a memory for storing a plurality of payment and non-payment applications;
a memory management unit for separating said applications in said memory, thereby permitting said non-payment applications to exist side-by-side with said payment application without requiring additional certification; and
a processor for executing one or more applications;
said memory management unit operable to assign a protected region within said memory to each application being executed by said processor; and
said payment applications operable to provide payment related services over a secured financial network and said non-payment applications operable to provide non-payment related services over an open network.

2. The terminal of claim 1 wherein said memory management unit terminates an application or shuts down said terminal if it is determined that said application is accessing memory outside its assigned region.

3. The terminal of claim 1 wherein said processor comprises control for authenticating applications to prevent execution of an unauthorized application on said terminal.

4. The terminal of claim 3 wherein said control is public key infrastructure based software.

5. The terminal of claim 1 wherein said non-payment applications provide e-services over the Internet.

6. The terminal of claim 5 wherein said e-services can be accessed by a consumer using a personal digital device over a wireless connection.

7. The terminal of claim 6 wherein said personal digital device comprises at least one of the following: a cell phone, a PDA, and a beeper.

8. A method for providing a plurality of services on a payment terminal, said method comprising the steps of:
storing a plurality of payment and non-payment applications in separate memory locations within said terminal, thereby permitting said non-payment applications to exist side-by-side with said payment application without requiring additional certification;
assigning a protected region within said memory to each application running on said terminal; and
selecting at least one application to be executed on said terminal by an operator;
executing said selected application on said terminal to provide service associated with said selected application; and
wherein said payment applications provide payment related services over a secured financial network and said non-payment applications provide non-payment related services over an open network.

9. The method of claim 8 further comprising the step of terminating said selected application if it is determined that said selected application is accessing memory outside its assigned region.

10. The method of claim 8 further comprising the step of shutting down said terminal if it is determined that said selected application is accessing memory outside its assigned region.

11. The method of claim 8 further comprising the step of authenticating applications to prevent execution of unauthorized application on said terminal.

12. The method of claim 8 wherein said non-payment applications provide e-services over the Internet.

13. The method of claim 12 wherein said e-services can be accessed by a consumer using a personal digital device over a wireless connection.

14. The method of claim 13 wherein said personal digital device comprises at least one of the following: a cell phone, a PDA, and a beeper.

15. A system for providing credit card verification at a point of sale, said system comprising:
a terminal for accepting data from a credit card in conjunction with point of sale purchase information;
means controlled by a remote system for providing acceptance information to said point of sale pertaining to said purchase;
said terminal further including:
means operative in response to information provided to said terminal from a user other than information provided by controlling applications other than said point of sale acceptance information in said credit card.

16. The system of claim 15 wherein said other provided information comes to said terminal under exclusive control of said user.

17. The system of claim 15 wherein said other provided information is provided by at least one of the following: a cell phone, a PDA, or a beeper.

18. The system of claim 15 further including means for maintaining applications which control point of sale acceptance separate from said other applications.
